(19) United States
(12) Patent Application Publication
(10) Pub. No.: US 2025/0338998 A1
(43) Pub. Date: Nov. 6, 2025

(54) Charcoal Grilling Apparatus And Accessories Including A Detachable Handle For Grill Grid

(71) Applicant: Pro-Chefgrills, LLC, Winchester, KY (US)

(72) Inventor: Ben D. Goff, IV, Winchester, KY (US)

(21) Appl. No.: 19/268,266

(22) Filed: Jul. 14, 2025

Related U.S. Application Data
(63) Continuation-in-part of application No. 17/967,477, filed on Oct. 17, 2022.
(60) Provisional application No. 63/256,038, filed on Oct. 15, 2021.

(51) Int. Cl. A47J 37/07; A47J 36/12

(52) U.S. Cl. CPC A47J 37/0786; A47J 36/12

(57) ABSTRACT

A detachable handle for a grilling apparatus including a grate, such as a charcoal grill is provided. The detachable handles includes a handle assembly removably connected to a grill extending element. The detachable handle further includes at least one fastener configured to secure the grill extending element to the grate.

This application is a continuation-in-part of U.S. patent application Ser. No. 17/967,477, filed on Oct. 17, 2022, which claims the priority to U.S. Provisional Patent Application Ser. No. 63/256,038, filed on Oct. 15, 2021, all of which are incorporated by reference herein in their entireties.

### TECHNICAL FIELD

This disclosure relates generally to a grilling apparatus and, more particularly, to various accessories for a charcoal grilling apparatus including a detachable handle configured to partially attach to the grill grid of the charcoal grilling apparatus, and improved grate rotators to improve the efficiency of the grilling process and the taste and flavor of the food.

### BACKGROUND

Grilling meats and other foods is quite popular for a wide range of activities, including but not limited to family meals, barbecues, picnics and tailgating activities. Although there are a number of different types of grills, including charcoal grills, these grills suffer from certain limitations, Namely, most charcoal grills include a lower portion or body having a grilling surface and a top portion or lid that covers the lower portion. Typically, the lid is designed to cover an entirety of the lower portion and may be attached to the lower portion via a hinged arrangement or completely removable.

In this type of arrangement, an individual must decide between leaving the lid off the grill, i.e., open grilling, which may be preferable for certain foods and typically allows for more precise control over the heat hitting the surface of the good. Alternatively, when the lid is positioned on the lower portion of the grill, the lid covers the entirety of the lower portion, i.e., closed grilling, which is also advantageous for certain foods, but may lead to mixed results because both sides of the food are picking up heat during the grilling process.

In closed grilling, an individual grilling the food cannot watch the food being grilled and, therefore, the individual must constantly remove the lid to check on the status of the food being grilled and then place the lid back on the lower portion to maintain the heat and flavor within the grill, which is tedious and increases the time for grilling. In addition, the pieces of meat or food on a standard charcoal grill does not cook at the same pace, so some pieces have to be removed or re-arranged, while others may not, which adds to the complexity of the grilling. While utilizing open grilling solves these problems, there are times an individual may need or want to use a combination approach, i.e., employ techniques of both open and closed grilling methods. Although certain grills may use hooks on the lid that may hang on the outer rim of the body of the grill (as shown in FIG. 1A), when hanging on the grill, nearly the entirety of the grill is open, i.e., heat is not retained and they are less than optimal at blocking wind.

U.S. Pat. No. 9,289,095 relates to a charcoal grilling apparatus that is designed to overcome the deficiencies addressed above with traditional charcoal grills by utilizing a half-lid arrangement. Despite overcoming certain of the deficiencies disclosed herein, the charcoal grilling apparatus in U.S. Pat. No. 9,289,095 is a full-size stand-alone grill. As a result, an individual that already owns a traditional full-size stand-alone grill would have to purchase another grill to obtain the benefits of the charcoal grilling apparatus in U.S. Pat. No. 9,289,095. Moreover, the half-lid arrangement does not allow for fully closed or fully opened grilling as it always half-open and half-closed.

In addition, it is advantageous for a charcoal grilling apparatus to include a partially removable or detachable handle configured to connect under the grid such that it does not interfere with grilling/cooking food on top face of the grid. The removable handle is also helpful in rotating and cleaning the grid. The removable handle may work with improved grate rotators positioned within the bowl of the grilling apparatus to rotate the grid for multiple zone cooking or grilling.

Accordingly, there is a need for various charcoal grilling apparatus accessories that may be used with existing traditional full-size stand-alone grills to allow more for more options and versatility in grilling methods, while further providing more efficient grilling by allowing the food being grilled to be viewed and rotated, utilizing less charcoal and retaining juices and flavor in the foods being grilled.

### SUMMARY

In accordance with one aspect of the disclosure, a detachable handle for a grilling apparatus including a grate is provided. The detachable handles includes a handle assembly removably connected to a grill extending element. The detachable handle further includes at least one fastener configured to secure the grill extending element to the grate.

In one embodiment, the handle assembly may include a first part fixedly connected to a second part. The first part of the handle assembly may be made of wood. The second part of the handle assembly may be made of metal. A distal end of the second part may be threaded. The grill extending element removably connects to the threaded distal end of the second part of the handle assembly. The handle assembly may include a threaded coupler to connect the grill extending element to the handle assembly. The grill extending element may include a substantially vertical portion connected to a substantially horizontal portion. The substantially horizontal portion of the grill extending element extends under a substantial entirety of the grate. The substantially horizontal portion of the grill extending element may be secured directly to the grate by the at least one fastener. The at least one fastener may be a pair of U-shaped bolts. Each of the pair of U-shaped bolts may be secured to the grate and the substantially horizontal portion of the grill extending element. The grill extending element may be made of same metal as the second part of the handle assembly.

In accordance with another aspect of the disclosure, a grilling apparatus is provided. The grilling apparatus includes a grate positioned within the bottom portion on a plurality of grate rotators mounted around the bottom portion. The grilling apparatus also includes a lid for covering the bowl in a closed grilling position. The grilling apparatus further includes a partially detachable handle including a first part removably connected to a second part. The first part of the partially detachable handle is configured to be removable from the second part such that the lid may completely cover the bowl.

In another embodiment, the first part of the partially detachable handle may include a substantially cylindrical handle for manipulating the grate. The grate may include a top grilling surface and an opposite, bottom surface. The second part of the partially detachable handle may be fixedly connected to the opposite, bottom surface of the grate. Each of the plurality of gate rotators may be sliding-type grate rotators. Each of the plurality of gate rotators may be rolling-type grate rotators.

In accordance with yet another aspect of the disclosure, a method of securing a partially detachable handle to a grilling apparatus including a bowl, a grilling surface grid, and a lid is provided. The method includes providing the partially detachable handle with a handle assembly removably connected to a grill connection element. The method also includes removing the lid from the bowl such that the grilling surface grid is exposed. The method further includes sliding a portion of the grill connection element under substantially an entirety of the grilling surface grid. Finally, the method includes securing the portion of the grill connection element to the grilling surface grid by a fastening device.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIGS. 1A and 1B are perspective views of a representative grilling apparatus known in the art in both a closed configuration and substantially open configuration;

FIGS. 2A and 2B are perspective views of a grill and a lid portion of the grill forming one aspect of this disclosure;

FIG. 3 is a perspective view of the lid portion showing both a handle and a hanger apparatus forming one aspect of this disclosure;

FIG. 4 is a perspective view of a first embodiment of a hanger apparatus forming one aspect of this disclosure;

FIG. 5 is a perspective view of the lid portion hanging on the grill in a first position forming one aspect of this disclosure;

FIGS. 6A and 6B are side views of the grill illustrating the lid portion hanging on the grill in the first position and a second position forming one aspect of this disclosure;

FIG. 7 is a perspective view of a second embodiment of a hanger apparatus forming one aspect of this disclosure;

FIGS. 8A and 8B are views of a knob hanger individually and a plurality of knob hangers connected to lid forming one aspect of this disclosure;

FIG. 9 is an exploded view of a traditional grilling apparatus including a grate and a grate support known in the art;

FIGS. 10A and 10B are views of a grate rotator individually and a plurality of grate rotators connected to grill forming one aspect of this disclosure;

FIG. 11 is a perspective view of a rolling-type grate rotator forming one aspect of this disclosure;

FIG. 12 is a perspective view of another rolling-type grate rotator forming one aspect of this disclosure;

FIG. 13 is a perspective view of a grill and a lid portion of the grill including a detachable handle and a grate rotator forming one aspect of this disclosure;

FIG. 14 is an enlarged cut-out view of FIG. 13 of the detachable handle attached to a grate of the grill forming one aspect of this disclosure;

FIGS. 15A and 15B are exploded views of the detachable handle forming one aspect of this disclosure;

FIGS. 16A and 16B are perspective views of a sliding-type grate rotator in isolation and connected with a corresponding grate support forming one aspect of this disclosure;

FIGS. 17A and 17B are perspective views of another sliding-type grate rotator in isolation and connected with a corresponding grate support forming one aspect of this disclosure; and

FIG. 18 is a perspective view of a rolling-type grate rotator forming one aspect of this disclosure.

### DETAILED DESCRIPTION

In the following detailed description, reference is made to the accompanying drawings and photographs that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a grilling apparatus with various accessories is hereinafter described.

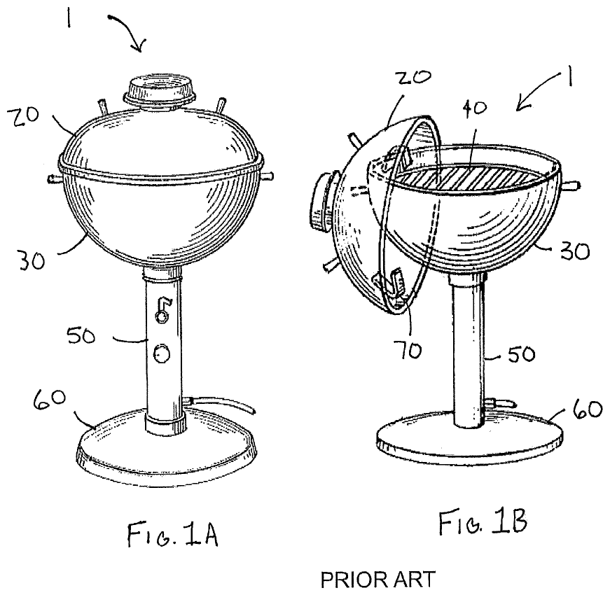

With reference to FIGS. 1A and 1B, a traditional grilling apparatus 1, such as a charcoal grill is illustrated. The grilling apparatus includes a full lid or hood 20, i.e., a lid that is configured to fully cover a bottom portion or bowl 30 of the grilling apparatus. The bottom portion includes a grid or grate 40 positioned within an upper portion of the interior of the bottom portion 30. The bottom portion 30 may be associated with one or more legs 50 for supporting the grilling apparatus. In the illustrated embodiment, the single leg 50 is connected to a base 60 that is positioned on the ground. As shown in FIG. 1B, the lid 20 may have a hook 70 to hang on an edge of the bottom portion of the grill. However, in this position, nearly the entirety of the grill is open such that beat is not retained during grilling and the lid is not particularly effective at blocking wind in this position as it does not substantially block the wind.

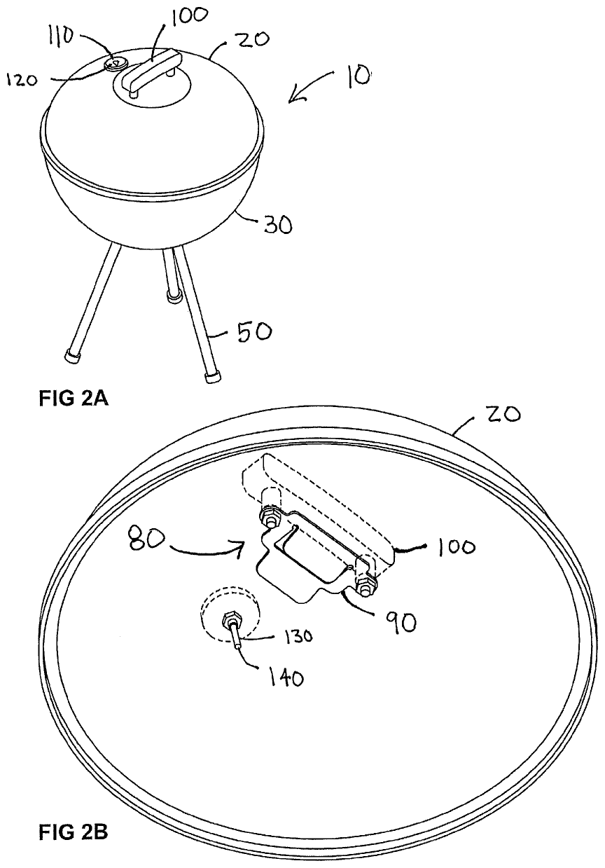

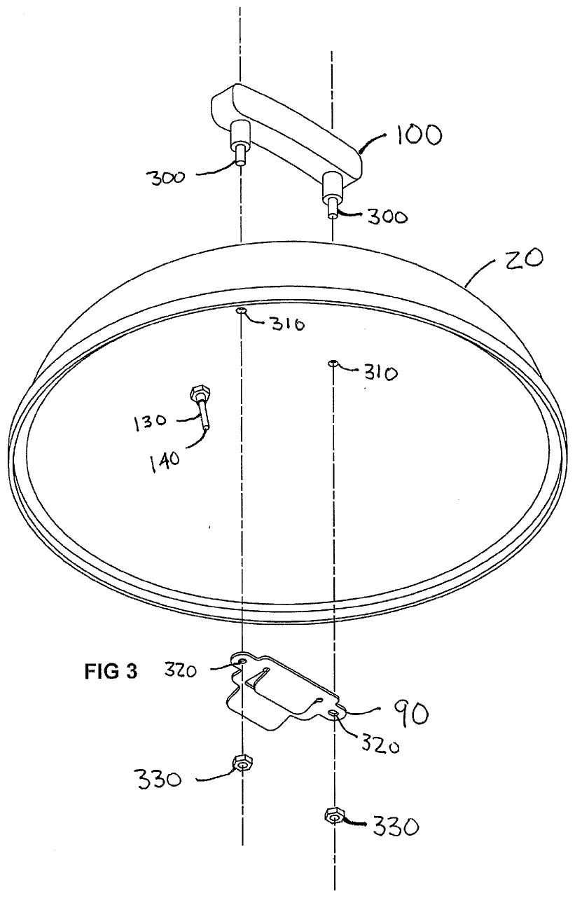

Turning to FIGS. 2A and 2B, a grilling apparatus 10, such as a charcoal grill configured to be used with a hood banger or hanging apparatus 80 for attachment to an existing grill lid 20 is disclosed. As shown in FIGS. 2A-8B, various embodiments of the hanging apparatus 80 is illustrated. Advantageously, the hanging apparatus 80 may take advantage of existing structures utilized on existing grills via one or more fasteners 300 to be retrofitted to almost any existing grill. For example, as shown in FIGS. 2B and 3, the hanging apparatus 80 may be connected to the lid 20 via an existing handle 100 on an exterior of the lid for moving the lid between an open and closed grilling position.

The hanging apparatus 80 may include at least one bracket 90 for connecting to the full lid 20, such as the lid that comes with the grill 10. Generally, the at least one bracket 90 should be made of a rigid material that is of suitable strength and capable of operating in a high temperature environment. For example, the at least one bracket 90 may be made of metal or a metal alloy, including but not limited to aluminum, aluminum alloy, steel, steel alloy, and stainless steel,

The bracket 90 may be connected to the full lid 20 in various ways. For example, the bracket 90 may be bolted to the lid via one or more fasteners 300, such as bolts, screws or the like as perhaps best shown in FIG. 3. In one embodiment, a handle 100 is connected to the bracket 90 via the fasteners 300. The handle 100 is positioned on exterior of the lid 20, while the bracket 90 is positioned on the interior of the lid 20. The handle 100 and bracket 90 may be connected via the fasteners 300 that each extend through a corresponding hole 310 in the lid 20 and then respective attachment holes or apertures 320 on each side of the bracket. The fasteners 300 may be connected to the bracket 90, lid 20 and handle 100 by nuts 330.

In addition to the handle 100, a thermometer 110 may also be connected to the lid 20, which is perhaps best shown in FIGS. 2A, 2B and 3, The thermometer 110 may have a readable face 120 showing a temperature reading on the exterior of the lid so that an individual may read the temperature while the lid 20 is positioned on the bottom portion 30 of the grill 10. The thermometer has a probe 130 that extends into the interior of the grill, i.e., within the interior of the lid 20 such that a probe tip 140 may obtain a temperature when the lid is closed.

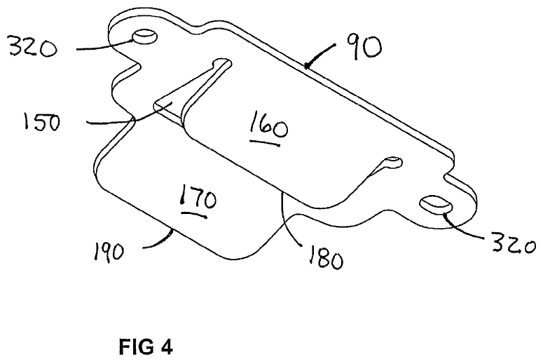

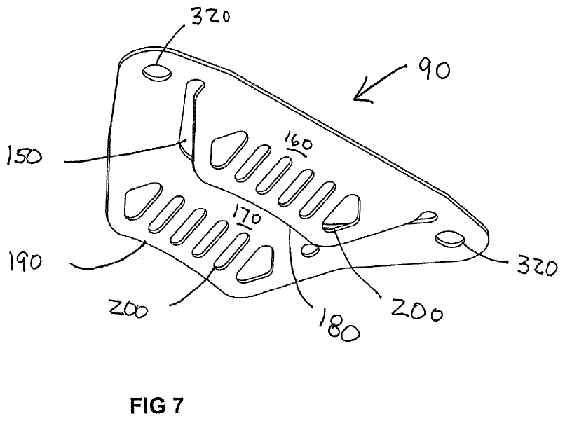

As shown in FIG. 4, the bracket 90 includes a body, one or more attachment holes 320 and a flange/tab/protrusion which is offset from the inner lid surface. The body of the bracket 90 includes an opening 150 defined by a first tab 160 that extends at least partially over the opening 150. A second tab 170 may be positioned below the opening 150. A front edge 180, 190 of each of the tabs 160, 170 is substantially straight. Turning to FIG. 7, another embodiment of a bracket 90 is illustrated wherein each of the tabs 160, 170 have a plurality of openings 200. The openings 200 may be different shapes and sizes. Unlike the embodiment shown in FIG. 4, the front edge 180, 190 of each of the tabs 160, 170 is slightly curved to match the kettle shape of the grilling apparatus 100, i.e., the curvature of the kettle. The curvature of the edges of the tabs is helpful in placing and re-positioning the lid on the perimeter of the kettle or bowl and improves sliding between the hanger and the kettle.

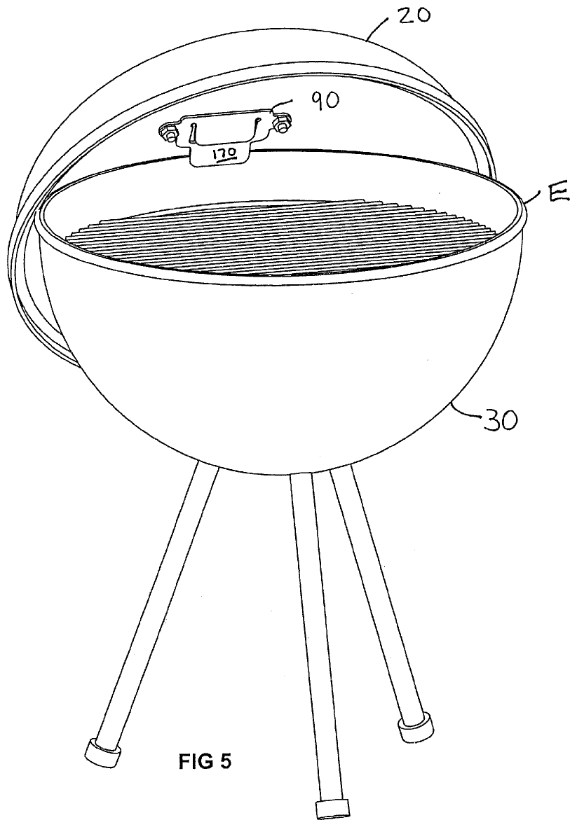

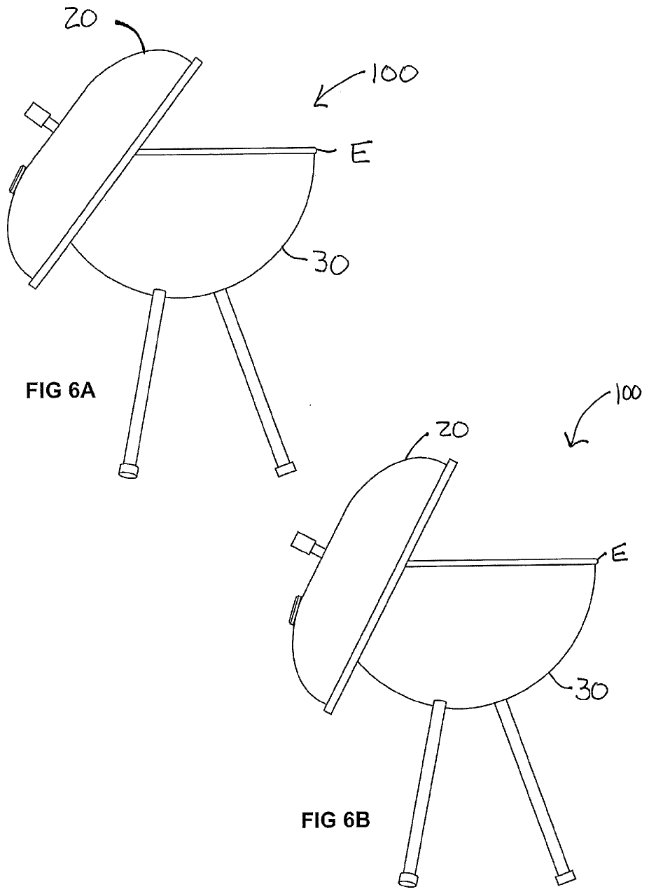

In use, one of the tabs 160 or 170 may be used to extend over an outer edge of the grill lid 20 such that the lid hangs in one of two positions as perhaps best shown in FIGS. 6A and 6B. Specifically, the lid 20 hangs on the outer edge (E) of the bowl 30 the lid 20 hangs on the outer edge (E) via one of the tabs such that about half of the bowl 30 of the grill 100 is covered by the lid 20. FIG. 6A illustrates a side view of the lid 20 covering about a quarter of the bowl 30 as shown in FIG. 5. It should be appreciated that the lid 20 is hanging on the outer edge (E) of the bowl 30 via the second tab 170 in FIGS. 5 and 6A. As a result, the existing lid with the hanging apparatus may be used rather than a conventional lid or a half-lid. Advantageously, the hood hanger 80 allows the lid to swivel or rotate to the other side of the grill to allow for open grilling, i.e., no lid. Importantly, the lid on the other side of the grill now blocks the wind to allow for more control of open grilling. In the position illustrated in FIGS. 5 (and 6A), the lid is positioned for heat retention (warm air zones) and also blocks wind. The lid may be easily repositioned around the perimeter of the bowl or kettle.

A different tab than the one shown used in FIGS. 5 and 6A may be used to extend over an outer edge of the grill lid such that the lid hangs in a second position as perhaps best shown in FIG. 6B, i.e., the first tab 160. Specifically, the lid 20 hangs on the outer edge (E) such that only a portion of the bowl of the grill is covered by the lid, i.e., less than half the bowl is covered by the lid in this position (less grate coverage). For example, in one particular embodiment, the lid 20 only covers about a quarter of the bowl 30 such that it operates at essentially the same efficiency as a half-lid arrangement. Again, the hood hanger allows the lid to swivel or rotate to the other side of the grill to allow for open grilling, i.e., no lid. Importantly, the lid on the other side of the grill now blocks the wind to allow for more control of open grilling. In the position illustrated in FIG. 6B, less heat retention is provided, but it provides greater access to the food being grilled.

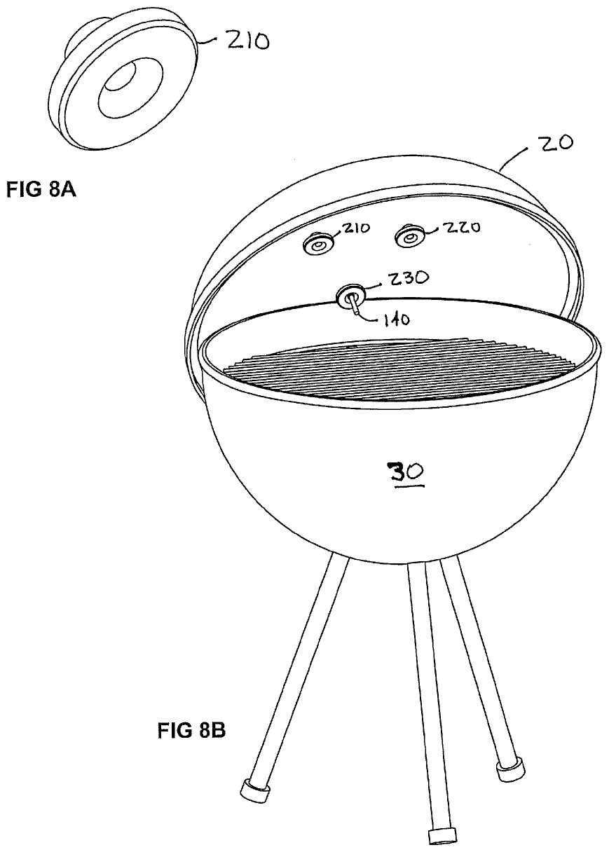

In still yet another embodiment illustrated in FIG. 8A and 8B, a plurality of knob hangers are used. Specifically, the bracket 90 is replaced by a first knob hanger 210 and a second knob hanger 220 that are spaced from each other. As illustrated, each knob hanger is similar in shape to an air hockey paddle, wherein a top cylindrical portion extends into an oversized rim portion having a circular shape. An interior of the rim portion, i.e., a bottom surface has a recessed portion. These knob hangers may connect to the handle and may be used instead of wingnuts that are used in other embodiments with the bracket. Both of these knob hangers may be used to extend over an outer edge of the grill lid 20 such that the lid hangs in a first position. A third knob hanger 230 may replace a wing nut on the thermometer and may be used to extend over an outer edge of the grill lid 20 such that the lid hangs in a second position. This second position, i.e., the “thermometer” location provides for greater coverage over the grilling surface while still providing reasonable access to the food on the grate.

Similar to the hanger 80, this embodiment of the knob hanger has a body, a mounting hole and a flange/hook. It should be appreciated that that the knob type hanger may be adapted with a sleeve bearing such that it can roll instead of slide along the rim, which makes repositioning of the grill lid 20 easier. It should also be appreciated that that the knob type hanger may be rotatably connected to the fastener.

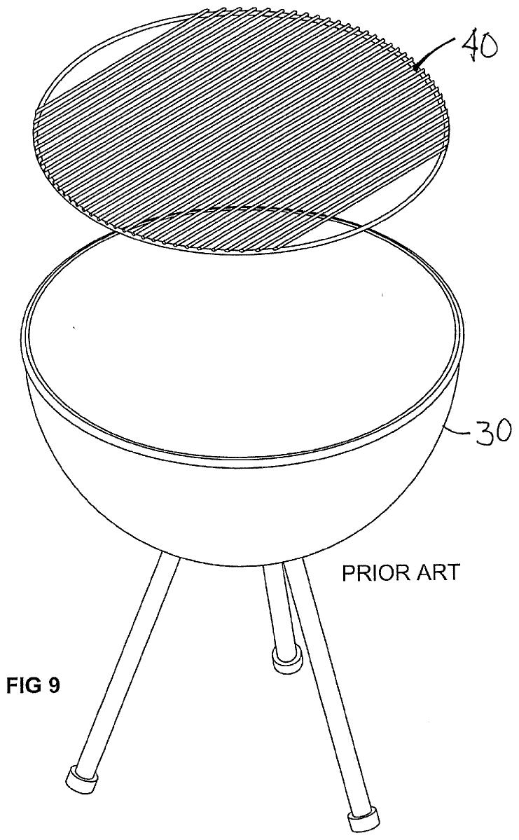

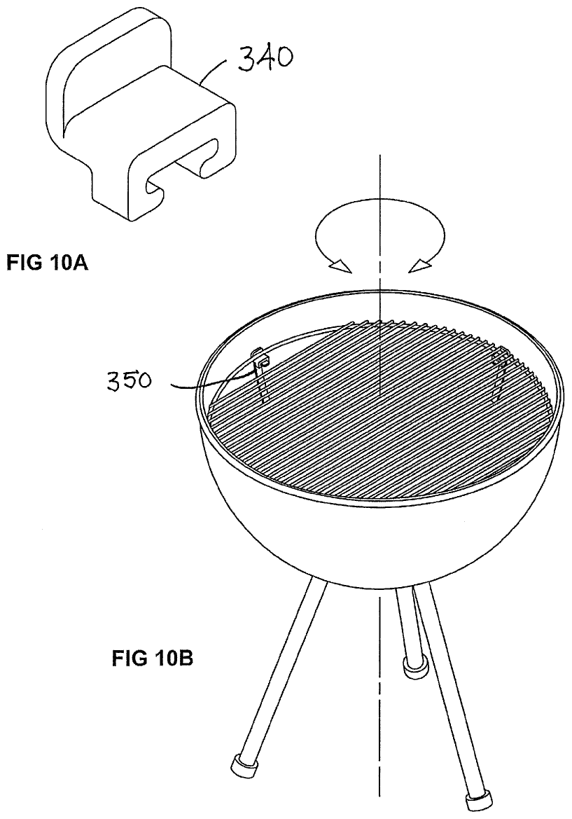

Turning to FIG. 9, a representative grill is shown with a grilling surface or grate 40 positioned on an inner ring (not shown) formed in the interior of the bowl 30. With reference to FIGS. 10A and 10B, the inner ring is replaced by multiple small grate rotators 340 that would fit on the end of each of four grate supports 350 positioned within the bowl 30 of the grill 100. This “sliding-type” rotator has a clamp portion, a horizontal portion for the grate to slide upon, and an optional vertical portion to help assist in keeping the grate centered. The horizontal portion extends to the inside walls of the grill's kettle or bowl.

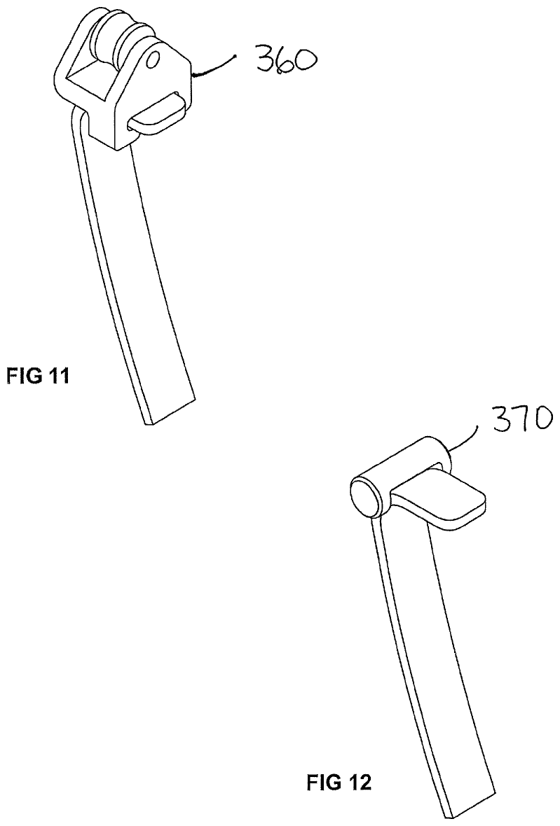

In one embodiment, the top of each of the grate rotators has a curved slot or groove cut out for the grate to sit in and rotate. Alternatively, a centering structure has a polished or low friction sliding surface (instead of a groove), which allows the grate to sit in and rotate. An attachment means is located on a front face for attaching the centering structure to the grilling apparatus. With reference to FIG. 11, a rolling-type grate rotator 360 is illustrated. The rotator 360 includes a grate support socket or clamp, roller support structure, hole for an axle, the axle, and a roller. Advantageously, the rotator 360 may be placed on any existing grate supports to aid in rotating the grate during grilling operations. Turning to FIG. 12, a grate insert 370 is illustrated. The insert 370 prevents the cooking grate 40 from falling into a notch between the grate-support structure and the interior bowl, which makes it easier to rotate the grate on top of the grate-support structure. In this embodiment, the insert is a cylinder with an elongated notch to engage or grab the sides of the grate support structure.

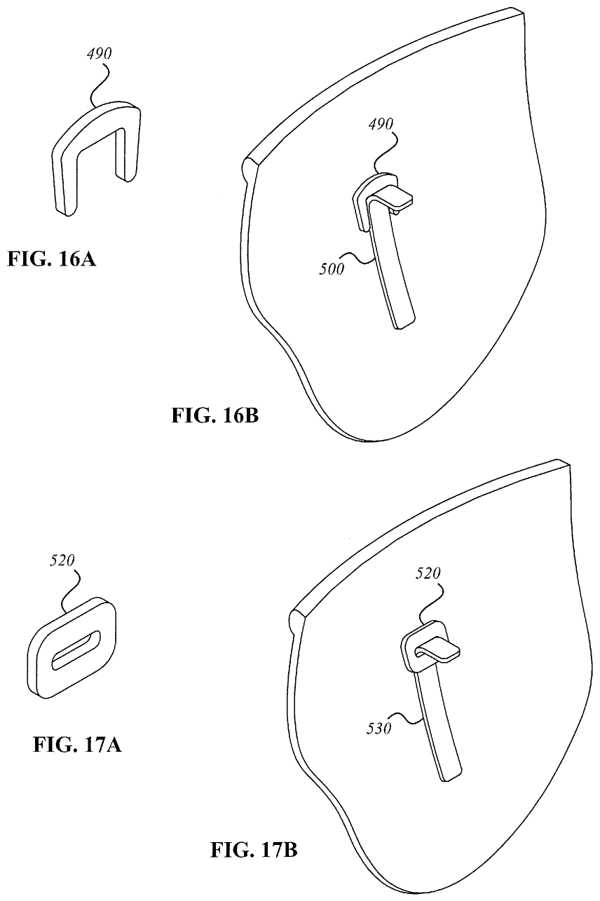

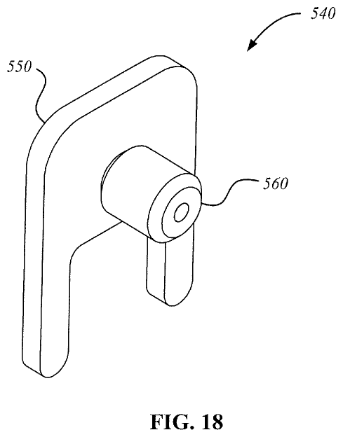

Turning to FIGS. 16A, 16B, 17A, 17B and 18, additional embodiments of grate rotators are illustrated. For example, FIGS. 16A/16B and 17A/17B illustrate different embodiments of a sliding-type grate rotator. As shown in FIG. 16B, one of a plurality of grate rotators 490 that fits on the end of corresponding grate supports 500 positioned within the bowl 30 of the grill 100. The grate rotator 490 is a notch that is configured to receive the grate support 500. Similarly, FIG. 17B illustrates one of a plurality of grate rotators 520 that fits on the end of corresponding grate supports 530 positioned within the bowl 30 of the grill 100. The grate rotator 520 includes a recess configured to receive the grate support 530. In both embodiments, the grate support includes a horizontal portion for the grate to slide upon and a vertical portion to help assist in keeping the grate centered. The horizontal portion extends to the inside walls of the grill's kettle or bowl.

With reference to FIG. 18, a rolling-type grate rotator 540 is illustrated. The rolling-type grate rotator 540 includes a grate support 550 and a hole for receiving a roller 560. Advantageously, the rotator 540 may be placed on any existing grate supports to aid in rotating the grate during grilling operations. Importantly, these grate rotators help to center and rotate the grate 40 on the grilling apparatus 10 and blocks the circular portion of the grate 40 from slipping in the notch between the grilling apparatus 10 and the grate support.

It should be appreciated that grill lid orientation provided by the various hangers described herein may be advantageously combined with the grate rotation provided by the disclosed grate rotator or insert embodiments described above. The combination of a hanging apparatus with a rolling-type grate rotator provides improved flexibility while grilling. For example, the grate may be easily rotated from a high-heat cooking zone into a partially covered warming zone without having to reposition each piece of food that is on the grilling surface with a grill utensil, i.e., tongs, which is time-consuming and inefficient. Importantly, both the various hanger embodiments and the grate rotator embodiments may be quickly and economically configured into use with conventional grill such that these conventional grills are converted into advanced cooking systems utilizing the existing structures already found in conventional grills.

In other embodiments, the lid may be in the shape of a partial hemisphere, i.e., a half lid and may be removably connected to the bottom portion of the grilling apparatus. In other words, the lid that comes with the grilling apparatus may be removed and the half-lid may be substituted, The partial hemisphere configuration may improve visualization for the individual using the grilling apparatus and can allow potentially beneficial exterior air to enter the grilling apparatus. Advantageously, this configuration may eliminate the need for a user to repeatedly open and close the grilling apparatus, which can cause heat loss and unpredictable grilling.

The half-lid may include a plurality of clips for attaching the half-lid to the grilling apparatus. When the lid is coupled to the bottom portion, they can be configured to form a sphere or egg-shaped structure. The clips may hang on a bottom portion of the grilling apparatus to allow the half-lid to rotate around a bottom portion of the grill. Specifically, the clips may clip to the bottom of the half-lid and then hang on the bottom portion of the grill for removable attachment. In yet another embodiment, the clips may be machined, partially machined, formed by bending from stamped shapes and combinations thereof, In still yet another embodiment, the plurality of clips may be replaced by welded bars positioned on the inside of the lid such that the lid may hang on the bars to hold it in place. In one particular embodiment, there may be three welded bars on the inside of the lid for the lid to hang.

The charcoal grilling apparatus accessory kit may also include a removable handle that can be used to articulate or pivot the grate. The grate may include a plurality of rods coupled to an outer perimeter. In one embodiment, the half-lid may define a pair of notches that can accommodate the handle. The handle is configured to removably attach to the existing grate of the grilling apparatus. Specifically, the handle would attached to the grate by hooks that cause pressure so that the handle will turn and lift the grate such that it may be rotated from a first position to a second position as discussed in more detail herein. As a result, the grate assembly can be oriented or movable relative to a firewall (described in more detail below) via the handle and can be used to control cooking temperature where, for example, the grate assembly may be transitioned such that the food is substantially covered by the half-lid may be exposed to a higher temperature than when the food is only partially covered or not covered by the lid. Furthermore, the handle may operate with or without an inner ring (described in more detail below) because the grate actually would rotate without the ring using the handle. In addition, an apparatus may be bolted to the grate such that it is easier to design a handle that would connect and disconnect to the bolted-on apparatus.

In another embodiment, the handle includes a spring-activated “squeeze” handle and opposed sections connected to one another by the spring-activated handle. In a first position, the opposed sections contact each other around the grate to be connected to the grate. In a second position, an individual may apply a force to the handle to move the opposed sections apart such that the handle may be removed from the grate.

In yet another embodiment, the handle may be replaced by a claw-like multi-function tool configured to turn the grate. In addition, the claw-like tool may be used to rake the coals in the bottom portion of the grilling apparatus (under the grate). The tool may hook into the grate such that it may be used to lift the grate out of the bottom portion of the grilling apparatus.

The charcoal grilling apparatus accessory kit includes a firewall, which may be connected directly to the grate assembly indirectly via an inner ring or removably connected to the bottom portion via brackets. Alternatively, the firewall may stand up by itself and positioned within the bottom portion such that it hangs about one inch above a bottom charcoal grate. The firewall can be positioned in a cavity defined by the bottom portion, wherein the firewall may divide the bottom portion into two sections.

In one embodiment, the firewall can divide the bottom portion into sections forming equal halves. However, any suitable configuration is contemplated including a firewall that can divide the bottom portion into any number of sections of any suitable size. The firewall can define a plurality of apertures, where each of the plurality of apertures can have pre-set diameters such that air can flow between the sections.

The charcoal grilling apparatus accessory kit may also include the inner ring configured to be positioned within the bottom portion of the grilling apparatus. The inner ring may have two wires for the top and a band for the lower part with notches to fit over the existing grate holders of the grilling apparatus, which is designed to keep the grate from spinning or rotating. In another embodiment, four hangers and four corresponding lock screws may also be used to fix the grate in position, i.e., prevent the inner ring from spinning. In addition, a strengthening rib may be provided to provide further structural support for the half-lid when the lid is cut in half.

In one embodiment, the inner ring may have rounded risers punched into the bottom in various places throughout the ring for the grate to ride on. As such, the grate is able raise off the bottom for less friction. The bottom will also have notches punched into it to catch on existing grate supports to keep ring from spinning.

In yet another embodiment, the inner ring may have a slot to fasten to existing grate supports for the grate to turn. Also, the inner ring will have corresponding slots for the firewall to slide down. The bottom of the firewall will be conformed to the grill so that the bottom rests on it with a gap underneath. Alternatively, the firewall may stand up by itself such that it may be set in various positions in the bottom of the grilling apparatus.

The grilling apparatus may also include a lower charcoal grate configured to be positioned horizontally within the bottom portion beneath the firewall. The charcoal grate may be semi-circular in shape such that the charcoal grate can be positioned only in the first section or alternatively the charcoal grate may be circular and can substantially cover the bottom portion. In one embodiment, the charcoal grate can be semi-circular and can be removable and interchangeable such that it can be positioned in either the first or second section. In this embodiment, the charcoal grate can hold charcoal above and away from the bottom of the grilling apparatus such that the charcoal can be vented in combination with one or a plurality of vent holes that can be defined by the bottom portion.

In yet another embodiment, a stand for use with a grilling apparatus is disclosed. The stand may be a trash-can like stand, i.e., a cylindrical base with an open top end for supporting the grilling apparatus. The open top end is supported by a plurality of legs that are foldable for storage purposes. Advantageously, this stand arrangement allows an individual to spin the grill into or away from the wind. Also, it allows an individual to balance the grill if on small incline by tilting the grill inside the grill stand. In one embodiment, vent holes are provided at bottom of stand. Furthermore, this stand may utilize a beveled bottom for tilting.

In still yet another embodiment, a tilt cart for a grilling apparatus is disclosed. The tilt cart includes a top surface having a circular open end for receiving the grilling apparatus. The top surface is connected to a bottom surface by a plurality of legs. On the bottom of each leg is a caster wheel for mobilizing the cart. The tilt cart allows rotation and movement of the grilling apparatus along with tilting of the grill. A lid hanger may be attached to the cart for storing the lid when not in use.

In yet one additional embodiment, the stand alone grill disclosed herein may come with a removable hinged lid. The hinged lid may come apart so that the front half of the lid may be removed such that the lid may be a half-lid as disclosed herein. If the hinge is not removed, then the hinged lid may function as a full-lid. The hinged lid may rely upon a spring for detachment.

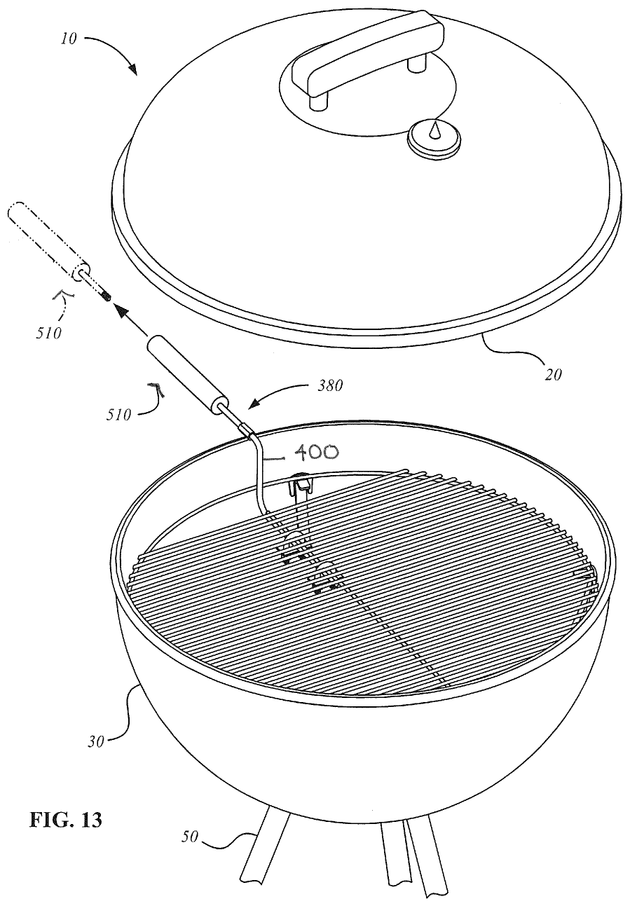

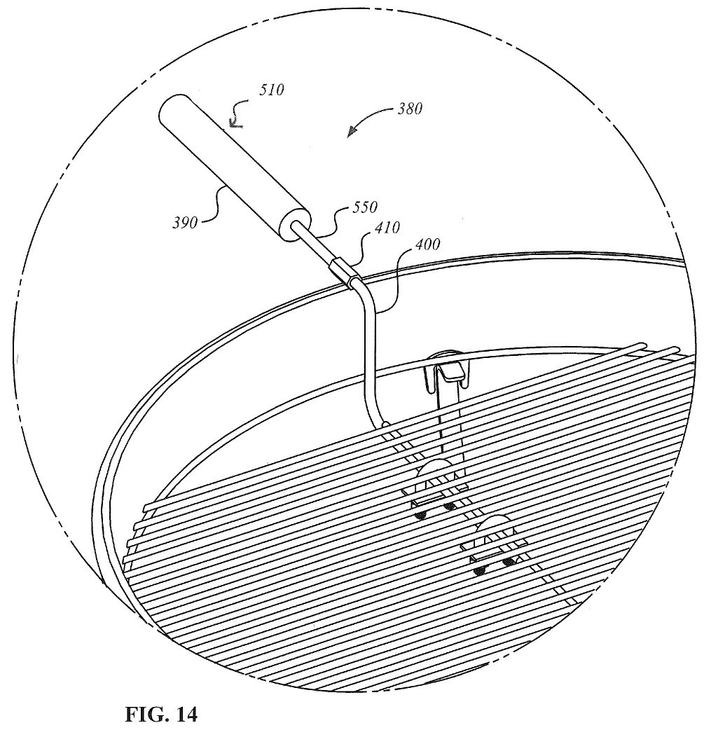

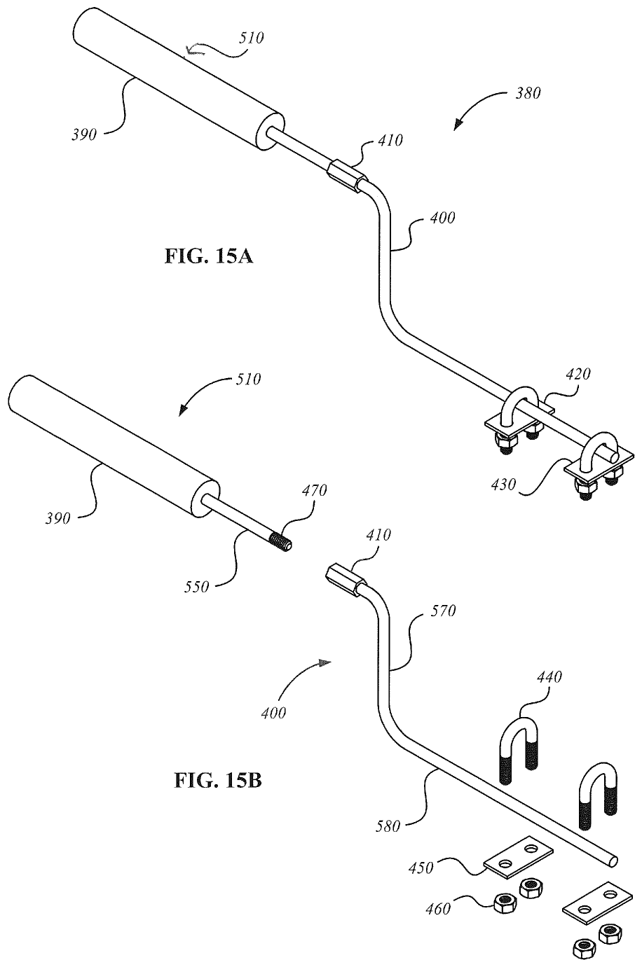

Turning to FIGS. 13-15A and 15B, a detachable handle 380 for the grilling apparatus 10 is illustrated. The detachable handle 380 may be used in conjunction with grate rotators (shown in better detail in FIGS. 16-18) to rotate the grid or grate 40 for various purposes, including multi-zone cooking and warming. As perhaps best shown in FIG. 14, the detachable handle 380 consists of two parts: a handle portion 510 and a “permanent” extension portion 400. The handle portion 510 and the extension portion 400 are removably connected together by a fastener or coupling element 410. The handle portion 510 also consists of two connected parts. The first part 390 may be cylindrically-shaped and made of wood or another rigid material. The first part 390 is the piece that a user would utilize to grip the detachable handle 380. A second part 550 extends from the first part 390 of the handle portion 510 and connects to a fastener or coupling element 410 at a first end of the coupling element. The second part 550 may be made of a rigid material, such as metal. The second part 550 is substantially thinner than the first part 390. The thinner metallic second part 550 has a threaded end 470 (shown in FIG. 15B) such that it is removably connected to the coupling element 410.

As perhaps best shown in FIGS. 15A and 15B, the extension portion 400 is connected to the coupling element 410 at a first end. The extension portion is made of a rigid material, such as metal. It has a vertical portion 570 that extends downward at approximately 90 degree angle and then extends again at approximately 90 degree angle to a horizontal portion 580 that is substantially perpendicular to the vertical portion 570. The vertical portion 570, the horizontal portion 580 and the second part 550 of the handle portion 510 are made of the same material. At the end of the horizontal portion is a second opposite end is that at a different height than the first end. In a typical orientation, the second end is positioned lower than the first end, i.e., underneath the grid or grate. It is shaped such that the vertical portion extends through a small opening between an outer edge of grate 40 and the grate itself. The horizontal portion 580 extends directly under the grate to not interfere with the grilling process. The extension portion 400 may be connected to the grilling apparatus 10 underneath the grid or grate 40 by one or more fasteners, i.e., the extension portion 400 is clamped over the grate wires by U-clamps that are locked underneath the grate or grilling surface (see FIG. 14).

In the embodiment shown in FIGS. 15A and 15B, a pair of U-shaped fasteners 440 may extend over the grate wires on top or grilling surface of the grate and around the lower end of the extension portion 400 to connect the extension portion under the grid or grate 40 to the grilling apparatus 10. The U-shaped fasteners 440 have threaded ends that extend through corresponding holes in washers 450 and are secured by corresponding nuts 460 to keep the extension portion firmly mounted to the grill.

Advantageously, the handle portion 390 is detachable from the permanent or extension portion 400 so that the lid 20 to completely cover the grill if desirable during the grilling of the food. The extension portion 400 of the detachable handle 380 stays connected to the grid, so it is not misplaced or lost but also stays out of the way when not in use. Since the horizontal portion traverses underneath the grate 40, it does not interfere with food placement on the grate or movement of food on the grate. In the past, handles attach to the cooking surface, which is inconvenient for cooking. This configuration is convenient because the consumer does not need a separate grid for a permanent handle set up. Rather, the detachable handle 380 is designed to be installed on the consumers existing grill. Again, the permanent or extension portion 400 connects under the grid such that it does not interfere with cooking food on top of grid.

For the use of the detachable handle, it is useful for placing the lid 20 half way on the grill top making for a good space in the grill to spread out hot coals or adding coals. When the grid is hot, the detachable handle 380 may be used to flip the hot grid 40 and clean the bottom side of grid. Also, the detachable handle 380 is helpful to hold the grid 40 securely in place while cleaning the top side of the grid. The detachable handle may work with the grid rotators and grill lid hanger for two zone cooking and helping in the rotation of the grid for “cold grate” cooking techniques. The use of the detachable handle makes the grill easier to clean and add more charcoal to the grill. After repeated use, the grate can become greasy and charred and, thus, the detachable handle provides a better way to manipulate the grate without getting one's hands dirty.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

1. A detachable handle for a grilling apparatus including a grate, comprising:
a handle assembly removably connected to a grill extending element; and
at least one fastener configured to secure the grill extending element to the grate.

2. The detachable handle of claim 1, wherein the handle assembly includes a first part fixedly connected to a second part.

3. The detachable handle of claim 2, wherein the first part is made of wood.

4. The detachable handle of claim 2, wherein the second part is made of metal.

5. The detachable handle of claim 4, wherein a distal end of the second part is threaded.

6. The detachable handle of claim 5, wherein the grill extending element removably connects to the threaded distal end of the second part of the handle assembly.

7. The detachable handle of claim 1, further including a threaded coupler to connect the grill extending element to the handle assembly.

8. The detachable handle of claim 1, wherein the grill extending element includes a substantially vertical portion connected to a substantially horizontal portion.

9. The detachable handle of claim 8, wherein the substantially horizontal portion of the grill extending element extends under a substantial entirety of the grate.

10. The detachable handle of claim 9, wherein the substantially horizontal portion of the grill extending element is secured directly to the grate by the at least one fastener.

11. The detachable handle of claim 10, wherein the at least one fastener is a pair of U-shaped bolts.

12. The detachable handle of claim 11, wherein each of the pair of U-shaped bolts is secured to the grate and the substantially horizontal portion of the grill extending element.

13. The detachable handle of claim 4, wherein the grill extending element is made of same metal as the second part of the handle assembly.

14. A grilling apparatus, comprising:
a bottom portion defining a cavity;
a grate positioned within the bottom portion on a plurality of grate rotators mounted around the bottom portion;
a lid for covering the bowl in a closed grilling position;
a partially detachable handle including a first part removably connected to a second part,
whereby the first part of the partially detachable handle is configured to be removable from the second part such that the lid may completely cover the bowl.

15. The grilling apparatus of claim 14, wherein the first part of the partially detachable handle including a substantially cylindrical handle for manipulating the grate.

16. The grilling apparatus of claim 14, wherein the grate includes a top grilling surface and an opposite, bottom surface.

17. The grilling apparatus of claim 16, wherein the second part of the partially detachable handle is fixedly connected to the opposite, bottom surface of the grate.

18. The grilling apparatus of claim 14, wherein each of the plurality of gate rotators are sliding-type grate rotators.

19. The grilling apparatus of claim 14, wherein each of the plurality of gate rotators are rolling-type grate rotators.

20. A method of securing a partially detachable handle to a grilling apparatus including a bowl, a grilling surface grid, and a lid, comprising:
providing the partially detachable handle with a handle assembly removably connected to a grill connection element;
removing the lid from the bowl such that the grilling surface grid is exposed;
sliding a portion of the grill connection element under substantially an entirety of the grilling surface grid; and
securing the portion of the grill connection element to the grilling surface grid by a fastening device.
